(19) United States
(12) Patent Application Publication
(10) Pub. No.: US 2026/0066792 A1
(43) Pub. Date: Mar. 5, 2026

(54) POWER CONVERSION SYSTEM

(71) Applicant: Delta Electronics (Shanghai) CO., LTD., Shanghai (CN)

(72) Inventors: Junhao XIA, Shanghai (CN); Tengshen ZHANG, Shanghai (CN); Yafeng WANG, Shanghai (CN); Linfeng ZHONG, Shanghai (CN); Yuanyuan SONG, Shanghai (CN)

(73) Assignee: Delta Electronics (Shanghai) CO., LTD., Shanghai (CN)

(21) Appl. No.: 19/313,900

(22) Filed: Aug. 29, 2025

(30) Foreign Application Priority Data
Aug. 30, 2024 (CN) 2024112181919

(51) Int. Cl. H02M 3/158; H02M 1/00; H02M 1/08; H02M 1/32

(52) U.S. Cl. CPC H02M 3/158; H02M 1/0006; H02M 1/08; H02M 1/32

(57) ABSTRACT

A power conversion system is provided with a first side and a second side, and includes: a power device, where a first port of the power device is connected in parallel to a DC voltage source or the first side, and a second port of the power device is connected in series between the first side and the second side; a bidirectional switch, connected in parallel to the second port of the power device; a driver, connected to the bidirectional switch; a master controller, connected to the driver; and a power supply, connected to the driver, where the driver controls the bidirectional switch when the master controller is powered down, enabling a current flowing into the power conversion system from the first side or the second side to remain an original flow direction.

### CROSS-REFERENCE TO RELATED APPLICATION

The present application claims the benefit of priority to Chinese patent application No. 2024112181919, filed on Aug. 30, 2024, the contents of which are incorporated herein by reference in their entireties for all purposes.

### TECHNICAL FIELD

The present disclosure relates to the technical field of power electronics and, in particular, to a power conversion system configured to enable bidirectional energy flow.

### BACKGROUND

In a distributed series-compensated type DC-DC battery energy storage system, a DC-DC converter is connected in series between a battery and a power conversion subsystem (PCS) or energy storage converter. The DC-DC converter may compensate for a voltage difference between the battery and the PCS during normal system operation.

It should be noted that the information disclosed in the above background section is only used for enhancement of understanding for the background of the present disclosure, and therefore may include information that does not constitute prior art known to those ordinary skilled in the art.

### SUMMARY

According to an aspect of the present disclosure, a power conversion system is provided that enables bidirectional energy flow. The power conversion system is provided with a first side and a second side, and includes:
a power device, where a first port of the power device is connected in parallel to a direct current (DC) voltage source or the first side, and a second port of the power device is connected in series between the first side and the second side;
a bidirectional switch, connected in parallel to the second port of the power device;
a driver, connected to the bidirectional switch;
a master controller, connected to the driver; and
a power supply, connected to the driver, where the driver controls the bidirectional switch when the master controller is powered down, thereby enabling a current flowing into the power conversion system from the first side or the second side to remain its original flow direction.

It should be understood that the above general description and the subsequent detailed description are only exemplary and explanatory, and do not limit the present disclosure.

### BRIEF DESCRIPTION OF THE DRAWINGS

The accompanying drawings herein are incorporated into the specification and form a part of the specification, illustrate the embodiments consistent with the present disclosure, and are used in conjunction with the specification to explain principles of the present disclosure.

Understandably, the accompanying drawings in the following description are only some of the embodiments of the present disclosure, and other accompanying drawings may be obtained based on these accompanying drawings without creative labor for those ordinary skilled in the art.

FIG. 1 shows a schematic diagram of a distributed series-compensated type DC-DC battery energy storage system in an embodiment of the present disclosure.

FIG. 2 shows a schematic diagram of a battery energy storage system with a bypass circuit in an embodiment of the present disclosure.

FIG. 3 shows a schematic diagram of a battery energy storage system with an SCR type bypass circuit in an embodiment of the present disclosure.

FIG. 4 shows a schematic diagram of a power conversion system configured to enable bidirectional energy flow in an embodiment of the present disclosure.

FIG. 5 shows a schematic diagram of another power conversion system configured to enable bidirectional energy flow in an embodiment of the present disclosure.

FIG. 6 shows a schematic diagram of a driving unit in an embodiment of the present disclosure.

FIG. 7 shows a schematic diagram of another driving unit in an embodiment of the present disclosure.

### DETAILED DESCRIPTION

In order to make the objectives, technical solutions and advantages of the embodiments of the present disclosure clearer, the technical solutions in the embodiments of the present disclosure will be clearly and completely described below in conjunction with the accompanying drawings in the embodiments of the present disclosure. Understandably, the described embodiments are only a part of the embodiments of the present disclosure, but not all of the embodiments. Generally, components of the embodiments of the present disclosure described and shown in the accompanying drawings herein may be arranged and designed in a variety of different configurations. Accordingly, the following detailed description for the embodiments of the present disclosure provided in the accompanying drawings is not intended to limit the scope of the present disclosure for which protection is claimed, but rather represents only selected embodiments of the present disclosure. Based on the embodiments of the present disclosure, all other embodiments obtained by those skilled in the art without creative labor are within the scope of protection of the present disclosure.

For purposes of the present disclosure, unless expressly indicated differently, the “power module” and the “power device” shall have the same meaning, the “driving unit” and the “driver” shall have the same meaning, the “master control unit” and the “master controller” shall have the same meaning, the “power supply module” and the “power supply” shall have the same meaning, and the “conversion module” and the “conversion device” shall have the same meaning.

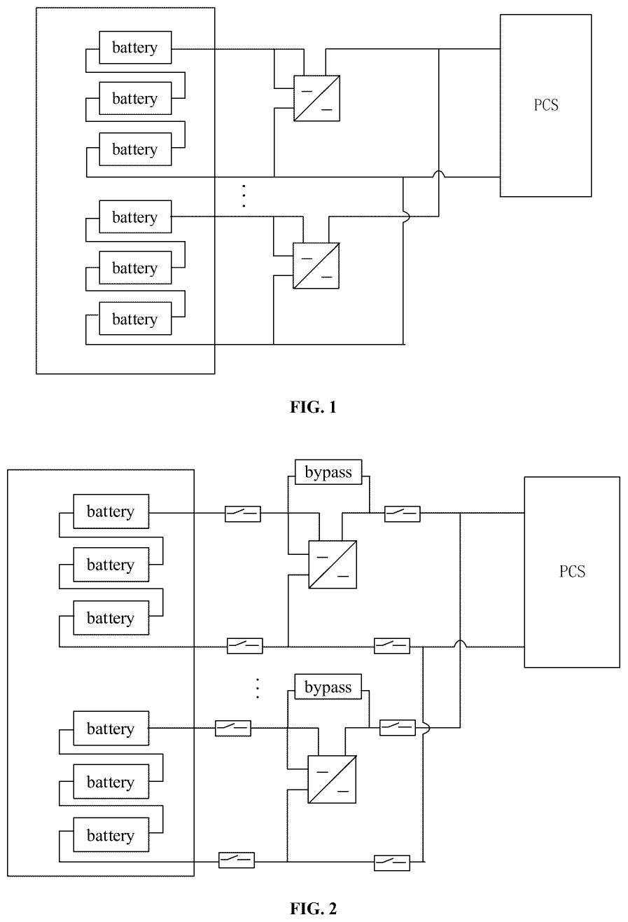

FIG. 1 shows a distributed series-compensated type DC-DC battery energy storage system, where a DC-DC converter is connected in series between a battery and a power conversion subsystem (PCS) or energy storage converter. The DC-DC converter may compensate for a voltage difference between the battery and the PCS during normal system operation. However, when a short circuit occurs at a PCS side port or a battery side port, the energy storage system described above is not capable of protecting its internal components, which results in damage to the components. Furthermore, once a power converter in the energy storage system fails, the energy storage system stops operation, which also results in a loss of energy storage capacity.

FIG. 2 shows a battery energy storage system with a bypass circuit. This energy storage system adds a bypass circuit based on the scheme of FIG. 1. When a short circuit occurs at the PCS side port or the battery side port, the energy storage system may enter a bypass state to avoid the damage to the components. When a current commutation is performed, the bypass circuit is first automatically turned off, and then is turned on in response to a trigger signal of a control module of the bypass circuit, thereby realizing the current commutation. However, in a case where a short circuit occurs at the PCS side port or the battery side port, and a power down failure of a power supply of a control unit of the bypass circuit is not relieved for the time being, when the current commutation is performed, the control module of the bypass circuit is not capable of providing the trigger signal to the bypass circuit. Consequently, after the commutation, the energy storage system enters an original failure state instead of a bypass state. This failure state may cause the damage to the components, and the stoppage of operation of the energy storage system under the failure state may also result in the loss of the energy storage capacity.

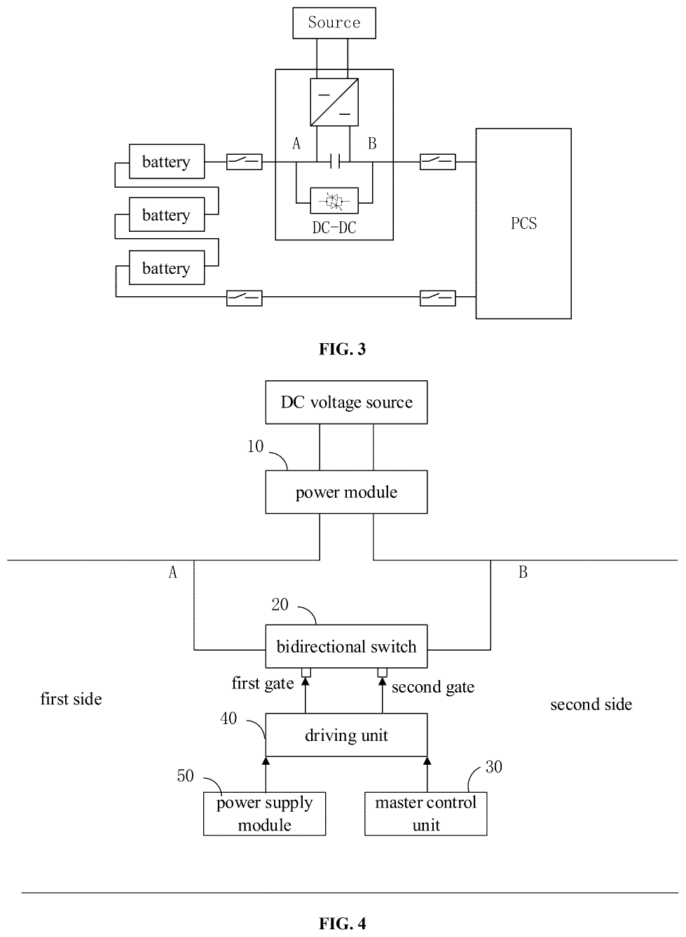

The bypass circuit in the embodiment of FIG. 2 may be a bypass circuit including a silicon controlled rectifier (SCR). FIG. 3 shows a battery energy storage system with an SCR type bypass circuit. As shown in FIG. 3, the bypass circuit is electrically connected to two ends of a capacitor, and the capacitor is bypassed when the energy storage system enters a bypass state. In this way, damage to the components of the energy storage system can be avoided, and loss of energy storage capacity can be reduced.

The SCR in the embodiment of FIG. 3 is a semi-control type device. When a forward voltage is applied from an anode to a cathode, and a forward trigger voltage is also applied from a gate with respect to the cathode, a PN junction in the SCR is turned on, and the device starts to be turned on, allowing large currents to pass. Once the SCR is turned on, even if a gate signal is removed, the SCR will continue to be turned on as long as an anode current remains above a maintenance current. To turn the SCR off, the anode current must be reduced below the maintenance current, or the forward voltage between the anode and cathode must be removed, which restores the device to its cut-off state.

Based on the above, it can be seen that the turning on of the SCR may be controlled by an external signal, but once the SCR is turned on, the SCR cannot be turned off directly through a control signal, but the turning off of the SCR needs to rely on an external condition, such as lowering the anode current to below the maintenance current or removing the forward voltage between the anode and the cathode. That is to say, when the energy storage system enters the bypass state, it is required to control the SCR through the control module of the bypass circuit to turn the SCR off. However, in the case where the control module of the bypass circuit also fails, even if the failure (a short circuit occurs at the PCS side port or the battery side port) of the energy storage system is relieved, as long as the failure of the control module of the bypass circuit is not restored, the energy storage system cannot actively exit the bypass mode.

Moreover, in the energy storage system illustrated in FIG. 3, in the event of a short circuit occurring at either the PCS-side port or the battery-side port, and, simultaneously, the control power to the bypass circuit is lost, the control module of the bypass circuit is unable to provide a trigger signal to the SCR during current commutation. As a result, the SCR cannot be turned on after the commutation. Consequently, the energy storage system reverts to its original fault state instead of entering the bypass state. This fault state may lead to damage to internal components and may also result in the loss of energy storage capacity due to the system's operational failure.

The deficiency in the above scheme and the solution proposed for the deficiency in the above scheme are the results of the inventor's practice and careful study, therefore, the discovery process of the above problem and the solution proposed for the above problem in the present disclosure hereinafter should be the inventor's contribution to the present disclosure in the course of the present disclosure.

The following provides a detailed description for the exemplary embodiment in conjunction with the accompanying drawings and the embodiments.

FIG. 4 shows a power conversion system configured to enable bidirectional energy flow in an embodiment of the present disclosure. As shown in FIG. 4, the power conversion system configured to enable bidirectional energy flow in the embodiment of the present disclosure includes a power module 10, a bidirectional switch 20, a master control unit 30, a driving unit 40, and a power supply module 50.

As shown in FIG. 4, the power conversion system configured to enable bidirectional energy flow is provided with a first side and a second side. In some embodiments, a first port of the power module 10 is connected in parallel to a DC voltage source or the first side. A second port of the power module 10 is connected in series between the first side and the second side.

The power module 10 described above may be powered by the DC voltage source, or may be powered by the first side.

In some embodiments, the power module 10 may be a DC-DC converter.

The bidirectional switch 20 is connected in parallel to the second port of the power module 10 described above.

The master control unit 30 is connected to the driving unit 40. The master control unit 30 may control the power module 10 and the bidirectional switch 20. When the power supply module 50 is powered down, even though the master control unit 30 fails, the driving unit 40 can still control the bidirectional switch 20, enabling a current flowing into the power conversion system from the first side or the second side to remain an original flow direction.

It can be understood that the power supply module 50 in the above embodiment may supply power to the master control unit 30, and the failure of the master control unit 30 in the above embodiment may be a failure of the power supply module 50, and thus the power supply module 50 is not capable of providing the power supply for the master control unit 30 in the normal operation state.

In some embodiments, in the case where the power supply module 50 is not capable of providing the power supply for the master control unit 30 in the normal operation state, the power supply module 50 may still enable the driving unit 40 to operate normally.

In some embodiments, when the power conversion system is in normal operation, the master control unit 30 controls a converter of the power conversion system to output a negative voltage to control turning off of the bidirectional switch 20.

In some embodiments, the bidirectional switch 20 described above may have a first gate and a second gate. In some embodiments, the bidirectional switch 20 may be a bidirectional active switch. In some embodiments, the bidirectional active switch may be one of a thyristor, a silicon-based metal-oxide semiconductor field effect transistor (Si-based MOSFET), a silicon carbide metal-oxide semiconductor field effect transistor (SiC-based MOSFET), and an insulated gate bipolar transistor (IGBT), or a combination thereof.

In some embodiments, the bidirectional switch 20 may be a bidirectional SCR. It can be understood that when a first side of the bidirectional switch 20 is turned on, the current is capable of flowing from the first side to the second side in FIG. 4; and when a second side of the bidirectional switch 20 is turned on, the current is capable of flowing from the second side to the first side in FIG. 4.

In some embodiments, the power supply module 50 supplies power to the master control unit 30. The master control unit 30 is connected to the first gate of the bidirectional switch 20 and the second gate of the bidirectional switch 20. When the power supply module 50 is powered down, and the current flows from the first side to the second side, the driving unit controls the first side of the bidirectional switch 20 to be turned on, enabling the current to remain flowing from the first side to the second side. When the power supply module 50 is powered down, and the current flows from the second side to the first side, the driving unit controls the second side of the bidirectional switch 20 to be turned on, enabling the current to remain flowing from the second side to the first side.

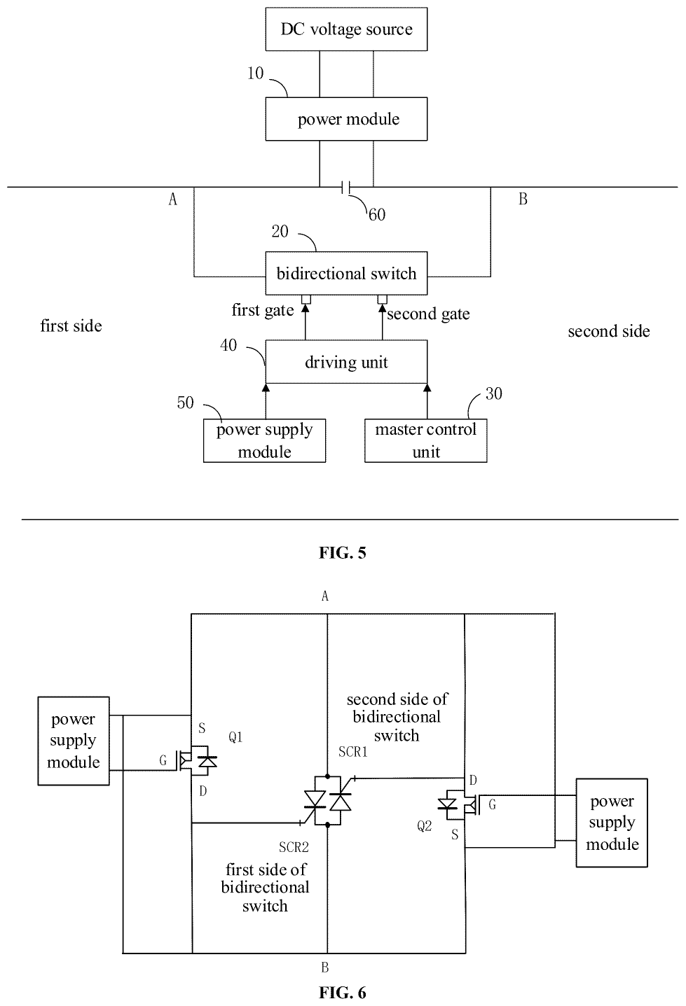

FIG. 5 shows a power conversion system configured to enable bidirectional energy flow in an embodiment of the present disclosure. As shown in FIG. 5, the power conversion system configured to enable bidirectional energy flow provided by the embodiments of the present disclosure includes a capacitor 60, a power module 10, a bidirectional switch 20, a master control unit 30, a driving unit 40, and a power supply module 50.

As shown in FIG. 5, the power conversion system configured to enable bidirectional energy flow is provided with a first side and a second side, where the capacitor 60 is electrically connected between the first side and the second side.

In some embodiments, a first port of the power module 10 is connected in parallel to two ends of the DC voltage source or the first side. A second port of the power module is connected in parallel to two ends of the capacitor 60.

In some embodiments, referring to the circuit of FIG. 5, the first port of the power module 10 may also be connected in parallel to two ends of the first side. The second port of the power module 10 is connected in parallel to two ends of the capacitor 60.

The power module 10 described above may be powered by the DC voltage source, or may be powered by the first side.

In some embodiments, the power module 10 may be a DC-DC converter.

The bidirectional switch 20 is connected in parallel to two ends of capacitor 60, and has a first gate and a second gate. In some embodiments, the bidirectional switch 20 may be a current-driven semi-control type device. In some embodiments, the bidirectional switch 20 may be a bidirectional SCR. It can be understood that when a first side of the bidirectional switch 20 is turned on, the current is capable of flowing from the first side to the second side in FIG. 5; and when a second side of the bidirectional switch 20 is turned on, the current is capable of flowing from the second side to the first side in FIG. 5.

The master control unit 30 is electrically connected to the first gate and the second gate. The power supply module 50 is electrically connected to the master control unit 30, and supplies power to the master control unit 30.

It should be noted that the driving unit 40 may include a first driving circuit and a second driving circuit. In some embodiments, the master control unit controls the bidirectional switch 20 by controlling the first driving circuit, that is to say, the first driving circuit works when the master control unit 30 is in normal operation. The second driving circuit may work when the master control unit 30 fails.

It can be understood that the second driving circuit of the driving unit 40 may be as shown in FIG. 6.

As shown in FIG. 6, the driving unit 40 includes a first switch Q1 and a second switch Q2.

The first switch Q1 includes a control end G, a first end D and a second end S. The first end D of the first switch Q1 is electrically connected to the first gate (SCR2) of the bidirectional switch 20. The control end G of the first switch Q1 and the second end S of the first switch Q1 are connected in parallel to two ends of the power supply module.

The second switch Q2 includes a control end G, a first end D and a second end S. The first end D of the second switch Q2 is electrically connected to the second gate (SCR1) of the bidirectional switch 20. The control end G of the second switch Q2 and the second end S of the second switch Q2 are connected in parallel to two ends of the power supply module.

When the power supply module 50 is powered down, and the master control unit 30 is not capable of controlling the bidirectional switch, the driving unit 40 starts to work. If the current flows from the first side to the second side, the first switch Q1 and the first side of the bidirectional switch 20 are turned on, enabling the current to remain flowing from the first side to the second side, and continue charging or discharging. If the current flows from the second side to the first side, the second switch Q2 and the second side of the bidirectional switch 20 are turned on, enabling the current to remain flowing from the second side to the first side, and continue charging or discharging. In this embodiment, the power supply module 50 is a low-voltage power supply system power supply module of the energy storage system. The power supply module 50 supplies power to the master control unit 30, and the normal operation of the master control unit 30 cannot be maintained when the power supply module 50 is powered down. That is to say, the embodiments of the present disclosure enable the current to remain the original direction to continue charging or discharging when the power supply module 50 is powered down and is not capable of maintaining the normal operation of the master control unit 30.

It can be understood that the first side of the bidirectional switch being turned on may be that the side where the first gate (SCR2) in FIG. 6 is located is turned on, and after the turning on, the current is capable of flowing from point A to point B in FIG. 6, but the current is not capable of flowing from point B to point A in FIG. 4. The second side of the bidirectional switch being turned on may be that the side where the second gate (SCR1) in FIG. 6 is located is turned on, and the current is capable of flowing from point B to point A in FIG. 6, but the current is not capable of flowing from point A to point B in FIG. 6.

In the above embodiments, the turning on of the bidirectional switch 20 may be controlled by the driving unit 40. When the power supply module 50 is normal, the master control unit 30 controls, through the driving unit 40, the bidirectional switch 20 to be turned on. When the power supply module 50 is powered down, the master control unit 30 does not work, and the power supply module 50 provides a control signal to the driving unit 40 to control the bidirectional switch 20 to be turned on. Regardless of whether the power supply module 50 is normal or not, the bidirectional switch 20 will be turned off due to the current commutation.

Combining the failure scenarios described in the embodiment of FIG. 2 and the embodiment of FIG. 3, the energy storage system enters the bypass state due to the failure, and the control module of the bypass circuit is powered down, i.e., the power supply module 50 in the embodiment of FIG. 4 is powered down and is not capable of maintaining the normal operation of the master control unit 30. In this failure scenario, the current in the embodiment of FIG. 2 and the embodiment of FIG. 3 is not capable of realizing the commutation. However, in the embodiment of FIG. 4 of the present disclosure, in the case where the energy storage system is in the bypass state, and the power supply module 50 is powered down and is not capable of maintaining the normal operation of the master control unit 30, when the current is switched from flowing from the first side to the second side to flowing from the second side to the first side, the second switch Q2 and the second side of the bidirectional switch 20 are capable of being turned on, enabling the current to flow from the second side to the first side; and when the current is switched from flowing from the second side to the first side to flowing from the first side to the second side, the first switch Q1 and the first side of the bidirectional switch 20 are capable of being turned on, enabling the current to flow from the first side to the second side. In other words, in the embodiments of the present disclosure, when the energy storage system is in the bypass state, and the power supply module 50 is powered down and is not capable of maintaining the normal operation of the master control unit 30, the current direction can be freely switched.

In the above embodiments, since the energy flows bidirectionally, the bidirectional switch 20 needs to be provided. However, the bidirectional switch 20 will be turned off due to the current commutation. Thus, the master control unit 30 is required to control the bidirectional switch 20 to be turned on. As described in the background section, the power supply of the master control unit 30 may fail, and in the related art, the bidirectional switch is not controllable when the power supply fails. In the embodiments of the present disclosure, the above driving unit 40 is provided, and the bidirectional switch is controlled to be turned on through the above driving unit 40 when the power supply fails, and therefore, in the case where the energy storage system is in the bypass state, and the power supply module 50 is powered down and is not capable of maintaining the normal operation of the master control unit 30, the current direction can be freely switched.

In some embodiments, the first side may be a battery cluster, and the second side may be a PCS. The first side may charge the second side (the current flows from the first side to the second side). The second side may also discharge to the first side (the current flows from the second side to the first side). When the system enters the bypass state, the bypass circuit bypasses the capacitor 60, and conversely, when the system exits the bypass state, the capacitor 60 participates in the charging and discharging operation of the system, where the capacitor 60 participates in the compensation of the battery voltage and maintains the voltage balance between the first side and the second side.

In some embodiments, the first switch and the second switch may be semiconductor devices that are triggered to be turned on through the negative voltage. In some embodiments, the first switch and the second switch may be p-channel metal-oxide-semiconductor field-effect (PMOS) transistors.

In some embodiments, a circuit topology of the driving unit includes one of the following: a pulse transformer switching circuit, an optoelectronic isolation switching circuit, a semiconductor switching circuit, and an integrated SCR switching chip circuit.

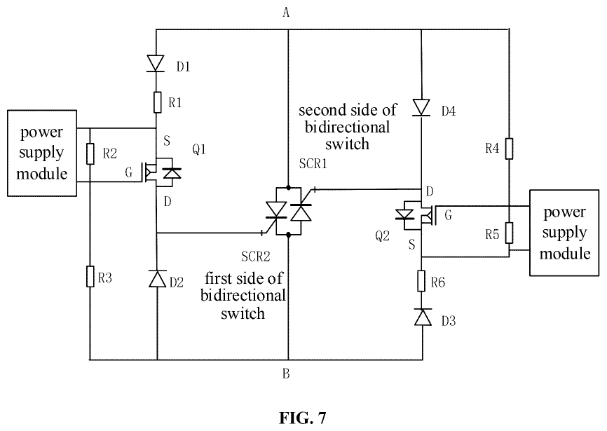

In some embodiments, as shown in FIG. 7, the control end G of the first switch is connected in series with a first resistor R3, and then is electrically connected to a first end of the bidirectional switch. The control end G of the second switch is connected in series with a second resistor R4, and then is electrically connected to a second end of the bidirectional switch.

As shown in FIG. 7, in some embodiments, the first end D of the first switch is connected in series with a first diode D2, and then is electrically connected to the first end of the bidirectional switch, where a cathode of the first diode is electrically connected to the first end of the first switch. The first end D of the second switch is connected in series with a second diode D4, and then is electrically connected to the second end of the bidirectional switch, where a cathode of the second diode is electrically connected to the first end of the second switch.

In some embodiments, the second end S of the first switch is connected in series with a third resistor R1 and a third diode D1 in sequence, and then is electrically connected to the second end of the bidirectional switch, where an anode of the third diode is electrically connected to the second end of the bidirectional switch. The second end S of the second switch is connected in series with a fourth resistor R6 and a fourth diode D3 in sequence, and then is electrically connected to the first end of the bidirectional switch, where an anode of the fourth diode is electrically connected to the first end of the bidirectional switch.

It should be noted that the two power supply modules shown in FIG. 7 may be the same power supply module.

In some embodiments, the power supply module 50 may include an auxiliary power supply and a conversion module. The conversion module is electrically connected to the auxiliary power supply.

In some embodiments, the auxiliary power source may be a low-voltage DC power source. The low-voltage DC power source may be a low-voltage power supply DC power source of the energy storage system. As an example, a voltage of the auxiliary power supply is 24 V.

In some embodiments, the power supply module 50 includes an auxiliary power supply and two conversion modules. A first conversion module is disposed between the driving unit 40 and the auxiliary power supply. A second conversion module is disposed between the auxiliary power supply and the master control unit 30.

In some embodiments, a resistor, such as resistor R2 and resistor R5 in FIG. 7, may also be connected in parallel to an output end of the conversion module.

It should also be noted that the first switch Q1 and the second switch Q2 in FIG. 7 may also be equivalent to diodes due to the characteristics of the MOS transistors themselves.

In the above embodiments, when the power supply module 50 is in normal operation, the driving unit 40 does not work, the master control unit 30 is powered normally; and when the system detects a failure, the controller may control the bidirectional switch to be turned on and off to cooperate with the normal operation of this system in which energy flows bidirectionally. When the power supply module fails (power down, not capable of supplying power to the master control unit 30), the current commutation is realized through the driving unit 40.

The present disclosure provides a power conversion system configured to enable bidirectional energy flow, which solves, at least to some extent, the problem of not being capable of controlling the direction of the battery charging and discharging currents when the energy storage system is in the bypass state, and the power supply of the control unit of the bypass circuit is powered down and the failure is not relieved for the time being.

In the embodiments of the present disclosure, the terms “first”, ‘second’ and “third” are used for descriptive purposes only, and are not to be understood as indicating or implying relative importance.

The term “and/or” in the present disclosure is merely a description for an associative relationship between associated objects, indicating that three kinds of relationships may exist. For example, A and/or B may indicate the existence of A alone, the existence of both A and B, and the existence of B alone. In addition, the character “/” in this article generally indicates that the associated objects are in an “or” relationship.

Some of the block diagrams shown in the accompanying figure are functional entities that do not necessarily have to correspond to physically or logically independent entities. These functional entities may be implemented in the form of software, or in one or more hardware modules or integrated circuits, or in different networks and/or processor devices and/or microcontroller devices.

After considering the specification and practicing the invention disclosed herein, those skilled in the art will easily conceive of other embodiments of the present disclosure.

The present disclosure is intended to encompass any variations, uses or adaptations of the present disclosure, where the variations, uses or adaptations follow the general principles of the present disclosure and include common knowledge or customary technical means in the art not disclosed in the present disclosure. The specification and embodiments are to be regarded merely as illustrative, and the true scope and spirit of the present disclosure are indicated by the appended claims.

What is claimed is:

1. A power conversion system configured to enable bidirectional energy flow, wherein the power conversion system is provided with a first side and a second side, and comprises:
a power device, wherein a first port of the power device is connected in parallel to a direct current (DC) voltage source or the first side, and a second port of the power device is connected in series between the first side and the second side;
a bidirectional switch, connected in parallel to the second port of the power device;
a driver, connected to the bidirectional switch;
a master controller, connected to the driver; and
a power supply, connected to the driver, wherein the driver controls the bidirectional switch when the master controller is powered down, enabling a current flowing into the power conversion system from the first side or the second side to remain an original flow direction.

2. The power conversion system according to claim 1, wherein the driver is connected to a first gate of the bidirectional switch and a second gate of the bidirectional switch;
when the power supply is powered down, and the current flows from the first side to the second side, the driver controls a first side of the bidirectional switch to be turned on, enabling the current to remain flowing from the first side of the power conversion system to the second side of the power conversion system; and
when the power supply is powered down, and the current flows from the second side of the power conversion system to the first side of the power conversion system, the driver controls a second side of the bidirectional switch to be turned on, enabling the current to remain flowing from the second side of the power conversion system to the first side of the power conversion system.

3. The power conversion system according to claim 1, wherein the first side is a battery cluster, and the second side is connected to a power conversion subsystem.

4. The power conversion system according to claim 1, wherein the power device is a DC-DC converter.

5. The power conversion system according to claim 1, wherein the power supply comprises an auxiliary power supply and a conversion device, and the conversion device is electrically connected to the auxiliary power supply.

6. The power conversion system according to claim 5, wherein the auxiliary power supply is a low-voltage DC power supply.

7. The power conversion system according to claim 1, wherein the bidirectional switch is a bidirectional active switch.

8. The power conversion system according to claim 7, wherein the bidirectional active switch comprises one or more of: a thyristor, a silicon-based metal-oxide semiconductor field effect transistor, a silicon carbide metal-oxide semiconductor field effect transistor, or an insulated gate bipolar transistor.

9. The power conversion system according to claim 2, wherein the driver comprises:
a first switch, comprising a control end, a first end and a second end, wherein the first end of the first switch is electrically connected to the first gate of the bidirectional switch, and the control end of the first switch and the second end of the first switch are connected in parallel to two ends of the power supply; and
a second switch, comprising a control end, a first end and a second end, wherein the first end of the second switch is electrically connected to the second gate of the bidirectional switch, and the control end of the second switch and the second end of the second switch are connected in parallel to two ends of the power supply; wherein
when the power supply is powered down, and the current flows from the first side of the power conversion system to the second side of the power conversion system, the first switch and the first side of the bidirectional switch are turned on, enabling the current to remain flowing from the first side of the power conversion system to the second side of the power conversion system; and
when the power supply is powered down, and the current flows from the second side of the power conversion system to the first side of the power conversion system, the second switch and the second side of the bidirectional switch are turned on, enabling the current to remain flowing from the second side of the power conversion system to the first side of the power conversion system.

10. The power conversion system according to claim 9, wherein a circuit topology of the driver comprises one of: a pulse transformer switching circuit, an optoelectronic isolation switching circuit, a semiconductor switching circuit, or an integrated silicon controlled rectifier (SCR) switching chip circuit.

11. The power conversion system according to claim 9, wherein the control end of the first switch is connected in series with a first resistor, and is electrically connected to a first end of the bidirectional switch; and
the control end of the second switch is connected in series with a second resistor, and is electrically connected to a second end of the bidirectional switch.

12. The power conversion system according to claim 9, wherein the first end of the first switch is connected in series with a first diode, and is electrically connected to a first end of the bidirectional switch; and a cathode of the first diode is electrically connected to the first end of the first switch; and
the first end of the second switch is connected in series with a second diode, and is electrically connected to a second end of the bidirectional switch; and a cathode of the second diode is electrically connected to the first end of the second switch.

13. The power conversion system according to claim 9, wherein the second end of the first switch is connected in series with a third resistor and a third diode in sequence, and is electrically connected to a second end of the bidirectional switch; and an anode of the third diode is electrically connected to the second end of the bidirectional switch; and
the second end of the second switch is connected in series with a fourth resistor and a fourth diode in sequence, and is electrically connected to a first end of the bidirectional switch; and an anode of the fourth diode is electrically connected to the first end of the bidirectional switch.

14. The power conversion system according to claim 1, further comprising:
a capacitor, electrically connected between the first side and the second side, wherein the second port of the power device is connected in parallel to two ends of the capacitor.

15. The power conversion system according to claim 1, wherein when the power conversion system is in normal operation, the master controller controls a converter of the power conversion system to output a negative voltage to control turning off of the bidirectional switch.
